(19) United States
(12) Patent Application Publication
(10) Pub. No.: US 2005/0271821 A1
(43) Pub. Date: Dec. 8, 2005

(54) Method for treating surfaces of textile

(75) Inventors: Mei-Hui Lee, Yungkang City (TW); Yang-Ping Shih, Hsintien City (TW); Kan-Nan Chen, Tanshui Town (TW); Jui-Chung Ni, Panchiao City (TW)

Correspondence Address: Richard L. Byrne, 700 Koppers Building, 436 Seventh Avenue, Pittsburgh, PA, 15219-1818, US

(73) Assignee: TAIWAN TEXTILE RESEARCH INSTITUTE

(21) Appl. No.: 10/966,863

(22) Filed: Oct. 15, 2004

(30) Foreign Application Priority Data
Jun. 4, 2004 (TW) 93116183

(51) Int. Cl. B05D 3/02; B05D 1/04

(52) U.S. Cl. 427/355; 427/372.2

(57) ABSTRACT

A method for treating surfaces of textile is disclosed. A coating solution, in which a polymer with reactive groups is utilized to give various functions, such as hydrophobicity, anti-bacteria or hydrophilicity (hygroscopicity) is formed. The coating solution with different viscosities, specially low viscosity, 100 cps or less, can be continuously coated onto a surface of the textile by employing a surface treating technique of gravure coating and appropriately adjusting the gravure meshes. After drying, a highly durable, washable and firm textile with single or multi-functions, such as outer hydrophobic surface and inner anti-bacterial and (or) hydrophilic (hygroscopic) surface.

### RELATED APPLICATIONS

The present application is based on, and claims priority from, Taiwan Application Serial Number 93116183, filed on Jun. 4, 2004, the disclosure of which is hereby incorporated by reference herein in its entirety.

### FIELD OF THE INVENTION

The present invention relates to a method for treating surfaces of textile, and more particularly, to a method of manufacturing textile with one or multi-functions.

### BACKGROUND OF THE INVENTION

Depending on the different requirements for the function of textile products, the textile products that merely provide a warmth-keeping function do not satisfy the requirement of the customers. The textile industry continues to develop textiles with more functions, for example, the textile products with single or composite functions such as hydrophobicity, anti-bacteria or hydrophilicity (hygroscopicity) The textile with the hydrophobic function is coated with a hydrophobic material on the outer surface thereof, the one with the hydrophilic function is coated with a hydrophilic material on the inner surface thereof, and the one with the anti-bacterial function is coated with a anti-bacterial material on the surface thereof.

However, when such different materials are coated on the same or different surfaces, respectively, some problems often occur, for example, the spreading layer is coated unevenly and unfirmly. The prior arts have disclosed the methods for solving the problem of the unfirm spreading layer resulting in less wash ability. For example, TW Patent Pub. No. 429,280 discloses a surface treatment method, in which fibers are activated in a high ion density microwave plasma system for forming free radicals on surfaces, and then grafted with functional monomer for giving the textile products with specific hydrophilic function. Moreover, JP Patent Pub. No. 11-256,476 discloses a method for the modification of a single surface of a woven or knit fabric or a non-woven fabric. The fabric is subjected to low-temperature plasma treatment, so as to obtain a woven or knit fabric or a non-woven fabric having different functions between the front and back surfaces. Furthermore, JP Patent Pub. No. 2001-159,074 discloses a method for modifying one side of a fabric. The textile or non-woven fabric is subjected to atmospheric plasma treatment for 8 hours, so as to obtain the textile or non-woven fabric having different function in surface and reverse face. Nevertheless, the single surface modification subjected to energy irradiation has disadvantages as follows. On one hand, the process of the fabric, one surface of which is modified by low-temperature plasma treatment for giving the textile products with specific hydrophilic function, must be carried out in a vacuum condition, but the apparatus is cost-intensive. On the other hand, during the process of the fabric is treated by atmospheric plasma, the gas mixtures that contain helium or argon, nitrogen and acrylic acid must be introduced by separating into several times in graft-processing for approximately 24 hours to 36 hours. Therefore, this process is difficult to perform a continuously mass production.

Besides, WO Patent Pub. No. 02,075,038 discloses a textile surface, which increases the viscosity of the functional resin(chemical) to inhibit it diffusing, so as to achieve the function of single side coating. However, this conventional coating or halftone transferring processing has disadvantages as follows. First, if a conventionally coating process is applied, the viscosity of the functional resin(chemical) must be increased for coating the resin(chemical) on the single side of the textile, but that will increase the instability of processing. Second, in the conventionally coating process, the amount of the resin must be coated in a range of 30 g/m² to 200 g/m². But that is difficult to carry out an ultra-thin coating treatment, and the basic fabric for processing is limited, as well as the softness of the textile is affected. Third, the intermediate, such as a thickening agent or an isolating agent, is added for increasing the viscosity of the resin, resulting in water spots on the textile products. Fourth, the conventionally coating process is difficult for coating on both sides, so the textile is difficult to have composite functions.

Therefore, it is necessary to resolve the problem of the textile with composite functions, so as to effectively coat spreading materials with different functions on one and the other sides of the textile, respectively, and to keep the textile soft, comfortable and washable.

### SUMMARY OF THE INVENTION

According to the aforementioned description, it is an aspect of the present invention to provide a method for treating surfaces of textile, for forming at least one ultra-thin functional spreading layer on the surface of the textile by a continuous process. Therefore, a firm, washable textile with single or multi-function is obtained.

It is another aspect of the present invention to provide a method for treating surfaces of textile, which utilizes a polymer with reactive groups to form a coating solution with various functions, such as hydrophobicity, anti-bacteria or hydrophilicity (hygroscopicity), by employing a surface treating technique of gravure coating, and appropriately selecting the groove shape and the gravure meshes. Next, the spreading solution with various functions and doses (such as viscosity, concentration, and thickness) is coated on the surface of the textile by employing a continuously coating technique. After an anchoring treatment such as thermal drying, the functional spreading solution is fixed on the surface of the textile by a reactive site, so as to produce a textile that has a functional surface, such as one hydrophobic surface and the other anti-bacterial and hydrophilic (hygroscopic) surface.

It is a further aspect of the present invention to provide a method for treating surfaces of textile by utilizing a gravure coating manner, which adjusts gravure meshes to freely regulate a viscosity, concentration, coating thickness and other variables of the functional chemicals. After an anchoring manner by an air drying such as thermal drying, an anchor is generated from the functional chemicals on the whole or partial surface of the textile. The drying process is speedy, and the method of the present invention increases a textile with multi-functions in fastness and wash durability.

It is still another aspect of the present invention to provide a method for treating surfaces of textile by utilizing a gravure coating manner, which selects the groove shape, meshes of the gravure roller, a viscosity and concentration (solid content) of the functional chemicals, to freely regulate a coating thickness of the functional resin (chemical).

It is yet another aspect of the present invention to provide a method for treating surfaces of textile by utilizing a gravure coating manner, which can directly adjust and control the dose and thickness of various functional chemicals coated on a surface of the textile. Therefore, the functional chemicals are uniformly coat on the surfaces of the textile, and different chemicals on different surfaces are functionally independent and cause no effect with each other.

It is still further aspect of the present invention to provide a method for treating surfaces of textile, which performs neither pre-processing such as surface activation or modification, nor any processing procedure. Instead, a spreading layer with single or multi-functions, such as hydrophobicity, anti-bacteria and hydrophilicity (hygroscopicity), is coated on the surfaces of the textile by a continuous process. Therefore, the investing in equipments is saved, as well as the power source and labor power are consumed less.

According to the aforementioned aspects of the present invention, the present invention provides a method for treating surfaces of textile, which utilizes a functional compound composition including a functional additive, for example, a polymer with at least one reactive group such as epoxy group, double bond (such as acrylic group, alkenyl group), isocyanate, silane, aziridine (or ethyleneimine), hydroxy group, organic acid and so on, to form a coating solution. According to the desired effect of the coated layer on the textile, the functional additive includes various functional resins(chemicals), for example, a hydrophobic agent, anti-bacterial agent such as organic polymer containing quaternary ammonium salts, or hydrophilic agent such as organic acid salt. The hydrophobic agent may be paraffin, polysiloxane or a fluoride. The viscosity of the spreading solution depends on the thickness of the desired coating layer. The method for treating surfaces of textile disclosed by the present invention is not limited by the viscosity of the coating solution. Even if the coating solution has less viscosity (less than 1000 cp of the viscosity), the gravure meshes is merely adjusted (by selecting the groove shape and gravure roller) to uniformly coat the ultra-thin layer, rather than using a thickening agent to increase the viscosity. The textile may be synthetic fiber fabrics such as knitting, woven and non-woven fabrics.

Hence, the present invention provides an ultra-thin gravure coating manner to coat the coating solution with functions such as hydrophobicity, anti-bacteria and hydrophilicity (hygroscopicity), which is formed by the polymer composition with the reactive group, on the surface of the textile. After an anchoring manner such as thermal drying, the functional components are fixed on the single or partial surface of the textile, so as to produce a textile that has composite functional surfaces, such as the outer hydrophobic surface and the inner anti-bacterial and hydrophilic (hygroscopic) surface. The present invention is applied not only to products in the prior cloth field, but also to the basic fabric for shoe materials and bags that need hydrophobic surfaces. Under this technology platform, the present invention is supposed to be applied in paper materials, non-woven fabrics and various substrates. This method for treating surfaces of textiles can simplify the treatment process increase the additional value, reduce the production cost, and enhance the value and competitiveness of the industry.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 depicts a diagram of the gravure coating apparatus for treating surfaces according to a preferred embodiment of the present invention; and

FIGS. 2 and 3 show images of fabrics of different materials treated by the treating method according to a preferred embodiment of the present invention.

### DETAILED DESCRIPTION OF THE PREFERRED EMBODIMENT

For more clarifying the method for treating surfaces of textile of the present invention, the following embodiment are described in detail how the method disclosed by the present invention is applied, and more specifically, the testing result disclosed herein is helpful to comprehend the advantages of the present invention.

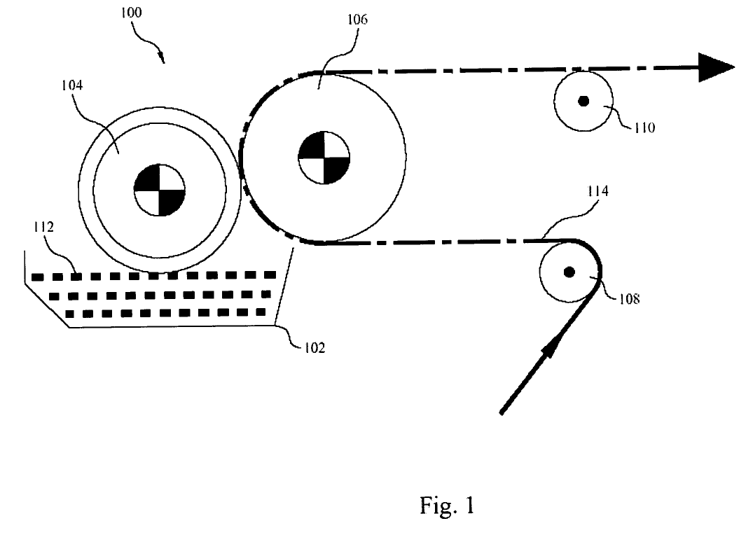

Reference is made to FIG. 1, which depicts a diagram of the gravure coating apparatus for treating surfaces according to a preferred embodiment of the present invention. The gravure printing apparatus 100 comprises a tank 102, a gravure roll 104, a pressure roller 106 and guiding rollers 108 and 110. A spreading solution 112 with various functions such as hydrophobicity, anti-bacteria and hydrophilicity (hygroscopicity), which is formed by a polymer composition with at least one reactive group, is placed in the tank 102 with an opening, wherein water, alcohol, reactive diluent or other organic hydrocarbon solvent may act as a solvent of the spreading solution 112, and the reactive group is preferably epoxy group, double bond (such as acrylic, alkenyl group), isocyanate, silane, aziridine (or ethyleneimine), hydroxyl group, organic acid or the like. The gravure roll 104 is disposed above the tank 102, and the pressure roller 106 is disposed on a side of the gravure roll 104. A textile 114, whose surface needs to be treated, is guided by the guiding roller 108 to pass between the gravure roll 104 and the pressure roller 106, and then guided by the guiding roller 110 to enter into a drying apparatus (not shown) for performing a drying and cross-linking process. A coating thickness of the textile 114 is in a range of about 0.5 mm to 2 mm, and a weight thereof is in a range of about 150 grams per meter (g/m) to about 200 g/m. The textile 114 moves on the apparatus at a speed of 2 meters per minute (m/min) and 10 m/min. The drying apparatus typically works as a thermal drying manner, and a thermal drying temperature is typically at a range of about 80 degrees Celsius (° C.) to 200° C.

When the gravure roll 104 rotates, the coating solution 112 in the tank 102 is brought to bumps on the surface of the gravure roll 104, and then is coated on a surface of the textile 114 at a pressing point between the gravure roll 104 and the pressure roller 106. Typically, the size of the bump on the surface of the gravure roll 104 is in a range of about 40 mesh per square inch (mesh/in²) to 200 mesh/in², and preferably in a range of about 40 mesh/in² to 180 mesh/in². A pressure between the gravure roll 104 and the pressure roller 106 is 2 kilograms weight per square centimeter (kgw/cm²) or less. A viscosity of the spreading solution 112 is not limited herein, however, preferably in a range of 10 centipoises (cps) to 10000 cps, and more preferably in a range of 200 cps to 5000 cps. A weight of the polymer composition with the reactive groups, which is brought onto the surface of the textile 114 by the coating solution 112, is less than 100 g/m². Actually, by applying the gravure coating manner disclosed by the present invention, the weight of the polymer composition with the reactive group is easily achieved to less than 50 g/m².

The size of bumps on the surface of the gravure roller 104 is able to control the transferred amount of the coating solution 112. The more the bumps are, the more the coating solution are brought, and vice versa. If a coating solution with less viscosity such as less than 1000 cps is applied, a textile coated with the polymer composition containing 0.5 g/cm² to 5 g/cm² of the reactive groups can be obtained, and the resultant coating layer is merely 1 μm in thickness.

The amount of the coating solution coated on the surface of the textile is controlled to be much less, so the problem that the coating solution diffuses to the other surface of the textile is prevented. Therefore, the textile, one surface of which is coated (printed) with hydrophobic coating layer and the other surface of which is coated with hydrophilic (hygroscopic) coating layer, is produced by applying the present method, so as to form the textile with coated layers of composite functions, such as an outer hydrophobic surface and an inner hydrophilic surface.

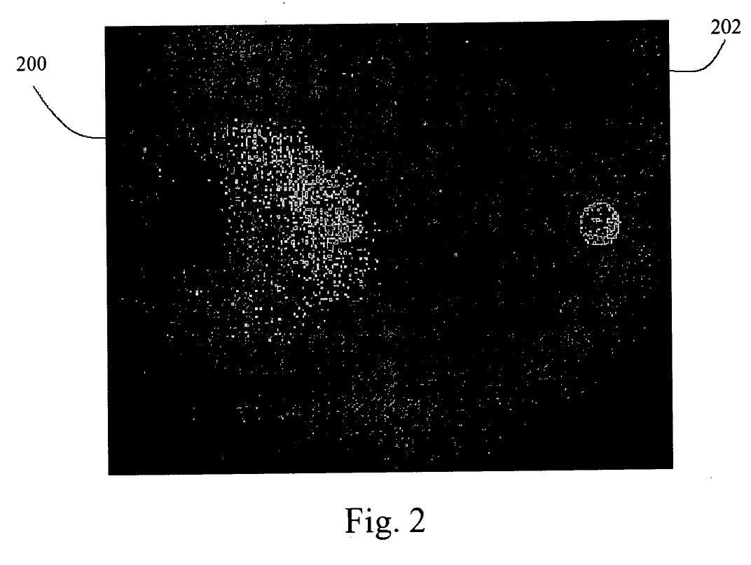

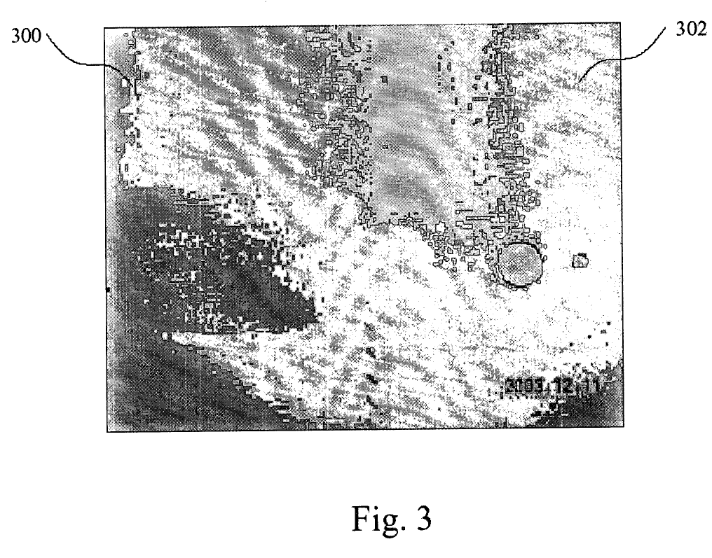

Reference is made to FIGS. 2 and 3, which show images of fabrics of different materials treated by the treating method according to a preferred embodiment of the present invention. The fabrics are woven fabrics of polyester materials, which are 0.35 mm and 0.24 mm in thickness, respectively, and 155 g/m² and 136 g/m², respectively. In FIGS. 2 and 3, the left surfaces 200 and 300 are treated with the hydrophilic (hygroscopic) coating layer, and the right surfaces 202 and 302 are treated with the hydrophobic coating layer. When water drops, the hydrophilic surfaces 200 and 300 make the water drops spread out and diffuse rapidly, but the hydrophobic surfaces 202 and 302 make the water drops gather and water-repellent thereon. Generally, the method for treating surfaces of textile disclosed by the present invention can enhance a textile, a thickness of which is in a range of about 0.5 mm to about 2 mm and a weight of which is in a range of about 120 g/m² to 300 g/m², to attain 80 or more in its hydrophobicity. With regard to hydrophilicity (hygroscopicity), a diffusion area of the hydrophilic surface of the textile is more than 1500 mm² at 20 seconds. Tab. 1 shows a relationship between the diffusion area and time. The comparative example is a textile without hydrophilic surface treatment, and the experimental embodiment is a textile with hydrophilic surface treatment. It is significantly observed that the textile with hydrophilic surface treatment is three times the diffusion speed of water on the textile without hydrophilic surface treatment. The water absorption of the hydrophilic surface of the textile is 2 seconds or less, and during the drying time of 40 minutes to 60 minutes, more than 93% of the water absorptive amount can be eliminated in such a drying rate.

TABLE 1
Diffusion Area of The Textile (mm²)

| Diffusion time | 5 seconds | 20 seconds | 3 minutes | 4 minutes |
|---|---|---|---|---|
| Comparative | 0 | 69 | 410 | 518 |
| Example | | | | |
| (Un-treated | | | | |
| Textile) | | | | |
| Experimental | 966 | 1670 | 3780 | 3931 |
| Embodiment | | | | |

The polymer with the reactive groups may be chosen from a hydrophilic or hydrophobic polymer, and the polymer itself acts as a carrier for fixing on the textile, and the hydrophobic agent, hydrophilic agent or the anti-bacterial agent can adhere to the polymer. The hydrophobic agent and the hydrophilic agent can enhance the hydrophilicity and hydrophobicity of the same, the anti-bacterial agent can make the textile to generate the function of anti-bacteria, and typically, the anti-bacterial ability is more than 99.9%. In addition, the reactive groups of the polymer anchors in the fibers of the textile, so it is washable and difficult to peel off. The textile is typically washed 18 times or more in average.

According to the aforementioned description, the present invention provides a method of treating surfaces of textile, which is applied with a gravure coating manner, by adjusting the mesh numbers and the viscosity of the coating(printing) solution with functional resin(chemicals), the amount of the printing solution coated on the surface of the textile is well controlled, so as to prevent from diffusing to the other surface and form the textile with a single or composite functional coating layer. The polymer in the printing solution has the reactive group. After fixing treatment such as thermal drying, the reactive group is fixed in the fibers of the textile, and the polymer with functional resin(chemicals) generates the anchor on the whole or partial surface of the textile product. The drying process is fast, and the fastness and wash durability of the textile with composite functions is greatly enhanced.

It can be comprehended from the aforementioned preferred embodiment of the present invention, as is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

1. A method for treating surfaces of textile, comprising:
providing a coating(printing) solution containing a functional compound composition;
performing a gravure step to coat the coating(printing) solution onto a surface of the textile; and
performing a drying process to remove a solvent in the coating solution, so as to fix the functional compound composition on the surface of the textile.

2. The method for treating surfaces of textile according to claim 1, wherein the functional compound composition comprises:
a polymer with at least one reactive group; and
a functional additive, wherein the functional additive is selected from a group consisting of a hydrophobic agent, a hydrophilic agent and an anti-bacteria agent.

3. The method for treating surfaces of textile according to claim 2, wherein the reactive group is epoxy group, double bond (such as acrylic, alkenyl group), isocyanate, silane, aziridine (or ethyleneimine), hydroxyl group, organic acid or the like

4. The method for treating surfaces of textile according to claim 2, wherein the hydrophobic agent is paraffin, polysiloxane, or fluorinated compound.

5. The method for treating surfaces of textile according to claim 1, wherein during the gravure step, the coating solution is continuously coated on the surface of the textile.

6. The method for treating surfaces of textile according to claim 1, wherein during the gravure step, the coating solution is continuously transferred on the surface of the textile with a gravure roller.

7. The method for treating surfaces of textile according to claim 6, wherein a size of a bump on a surface of the gravure roller is preferable in a range of about 40 meshes to about 200 meshes.

8. The method for treating surfaces of textile according to claim 6, wherein a size of a bump on a surface of the gravure roller is preferable in a range of about 40 meshes to about 180 meshes.

9. The method for treating surfaces of textile according to claim 6, wherein a pressure between the gravure roller and the textile is 2 kilograms weight per square centimeter (kgw/cm²) or less.

10. The method for treating surfaces of textile according to claim 1, wherein the drying process is preferred a thermal drying process.

11. The method for treating surfaces of textile according to claim 10, wherein a temperature employed by the thermal drying process is between about 50 degrees Celsius (° C.) and about 200° C.

12. The method for treating surfaces of textile according to claim 1, wherein a viscosity of the coating solution is between about 10 centipoises (cps) and about 10000 cps.

13. The method for treating surfaces of textile according to claim 1, wherein a viscosity of the coating solution is in a range of about 200 cps to about 10000 cps.

14. The method for treating surfaces of textile according to claim 1, wherein a weight of the functional compound composition on the surface of the textile is less than 100 grams per square meter (g/m²).

15. The method for treating surfaces of textile according to claim 1, wherein a weight of the functional compound composition on the surface of the textile is less than 50 g/m².

16. The method for treating surfaces of textile according to claim 1, wherein a weight of the functional compound composition on the surface of the textile is in a range of about 0.5 g/m² to about 5 g/m².

17. The method for treating surfaces of textile according to claim 1, wherein the solvent employed in the coating solution is an water, alcohol, reactive diluent or other organic hydrocarbon solvent.

18. A method for modifying surface of textile, comprising:
providing a solution comprising a functional additive and a polymer with a reactive group, wherein the reactive group is epoxy group, double bond (such as acrylic, alkenyl group), isocyanate, silane, aziridine (or ethyleneimine), hydroxyl group, organic acid or the like performing a gravure step to continuously transfer the solution onto a surface of the textile; and
performing a drying process to remove a solvent in the coating solution, so as to fix the functional compound composition on the surface of the textile.

19. The method for modifying surface of textile according to claim 18, wherein the functional additive is selected from a group consisting of a hydrophobic agent, a hydrophilic agent and an anti-bacteria agent.

20. The method for modifying surface of textile according to claim 19, wherein the hydrophobic agent is paraffin, polysiloxane, or fluorinated compound.

21. The method for modifying surface of textile according to claim 18, wherein during the gravure step, the solution is continuously transferred on the surface of the textile with a gravure roller.

22. The method for modifying surface of textile according to claim 21, wherein a size of a bump on a surface of the gravure roller is preferable in a range of about 40 meshes to about 200 meshes.

23. The method for modifying surface of textile according to claim 21, wherein a pressure between the gravure roller and the textile is 2 kgw/cm² or less.

24. The method for modifying surface of textile according to claim 18, wherein the drying process is preferred a thermal drying process.

25. The method for modifying surface of textile according to claim 24, wherein a temperature employed by the thermal drying process is in a range of about 50° C. to about 200° C.

26. The method for modifying surface of textile according to claim 18, wherein a viscosity of the solution is in a range of about 100 cps to about 10000 cps.

27. The method for modifying surface of textile according to claim 18, wherein a weight of the functional additive and the polymer with the reactive group on the surface of the textile is less than 100 g/m².

28. The method for modifying surface of textile according to claim 18, wherein a weight of the functional additive and the polymer with the reactive group on the surface of the textile is less than 50 g/m².

29. The method for modifying surface of textile according to claim 18, wherein a weight of the functional additive and the polymer with the reactive group on the surface of the textile is in a range of about 0.5 g/m² to about 5 g/m².
